(19) United States
(12) Patent Application Publication
(10) Pub. No.: US 2011/0084543 A1
(43) Pub. Date: Apr. 14, 2011

(54) Bead Seat Clincher

(75) Inventor: Paul Eric Lew, Las Vegas, NV (US)

(73) Assignee: REYNOLDS CYCLING LLC, West Jordan, UT (US)

(21) Appl. No.: 12/909,559

(22) Filed: Oct. 21, 2010

Related U.S. Application Data
(63) Continuation-in-part of application No. 12/455,393, filed on May 30, 2009, now abandoned.

(51) Int. Cl. B60B 21/10; B60B 21/00; B29C 70/00

(52) U.S. Cl. 301/95.102; 301/95.101; 264/572

(57) ABSTRACT

A bead seat clincher bicycle rim includes a tire supporting surface bounded by a first straight sidewall and a second straight sidewall wherein said bicycle rim does not comprise bead hooks. A method for forming a bead seat clincher rim includes forming composite plies in a bottom portion of a mold and placing a single piece upper portion over the bottom portion. A bladder is inflated in the center of the mold to form a closed cavity within the rim. The rim is cured and the bladder is deflated. The single piece upper portion and bottom portion of the mold are removed.

### RELATED DOCUMENTS

The present application is a continuation-in-part, and claims the benefit under 35 U.S.C. §120, of U.S. application Ser. No. 12/455,393, entitled “Wheel with Composite Rim,” filed May 30, 2009. This application is herein incorporated by reference in its entirety.

### BACKGROUND

Bicycle wheel rims are structural elements that retain a bicycle tire in place, provide braking surfaces, and provide attachment points for spokes. The wheel rims are subject to a variety of forces, including forces that are generated during acceleration, turning, braking, impacts as the tire passes over variations in the terrain, forces exerted on the rim by the inflated tire and other forces. For high performance applications, such as sprinting or bicycle racing, the mass, aerodynamics, and rotational inertia the bicycle rim are also significant design considerations.

### BRIEF DESCRIPTION OF THE DRAWINGS

The accompanying drawings illustrate various examples of the principles described herein and are a part of the specification. The illustrated examples are merely examples and do not limit the scope of the claims.

FIGS. 1A-1C are diagrams of illustrative bicycle rims which are designed to use bead hooks to retain a bicycle tire in place, according to one example of principles described herein.

FIG. 2A is a side view of an illustrative bicycle wheel that that includes a bead seat clincher rim, according to one example of principles described herein.

FIG. 2B is a cross sectional diagram of an illustrative bead seat clincher rim, according to one example of principles described herein.

FIGS. 2C and 2D are cross sectional diagrams of a tire being installed and inflated on the illustrative bead seat clincher rim, according to one example of principles described herein.

FIG. 3 is a diagram of an illustrative mold for a bead seat clincher rim, according to one example of principles described herein.

FIG. 4 is a flow chart which shows one illustrative method for forming a bead seat clincher rim, according to one example of principles described herein.

Throughout the drawings, identical reference numbers designate similar, but not necessarily identical, elements.

### DETAILED DESCRIPTION

As noted above, bicycle wheel rims are structural elements that retain the tire in place, provide braking surfaces, and provide attachment points for spokes. The wheel rims are subject to a variety of forces, including forces that are generated during acceleration, turning, braking, impacts as the tire passes over variations in the terrain, forces exerted on the rim by the inflated tire and other forces. For high performance applications, these forces can be significant due to higher traveling speeds, sharper cornering, higher tire inflation pressures and other factors. Additionally, for sprinting or bicycle racing, the mass, aerodynamics, and rotational inertia the bicycle wheel are important.

Traditionally, bicycles have almost universally used rims with bead hooks. Bead hooks are protrusions from the sidewalls of the rim that capture the bead of the tire and retain the tire on the rim as long as the tire is inflated and thus under pressure. However, the use of bead hooks introduces a number of constraints that have been appreciated by the inventors of the subject matter disclosed herein and will be described in some detail below.

Consequently, the present specification discloses and describes a bead seat clincher rim that includes a tire supporting surface bounded by a first straight sidewall and a second straight sidewall. The tire supporting surface includes a central indentation with sides having ascending slopes on either side, elevated retention features, straight sidewalls, and cups adjacent to the straight sidewalls, in which the elevated retention features are interposed between the ascending slopes and the cups. When a tire is inflated on the rim the beads of the tire are supported by the cups and the straight sidewalls of the tire supporting surface. Bead hooks are not used or needed.

In the following description, for purposes of explanation, numerous specific details are set forth in order to provide a thorough understanding of the present systems and methods. It will be apparent, however, to one skilled in the art that the present apparatus, systems and methods may be practiced without these specific details.

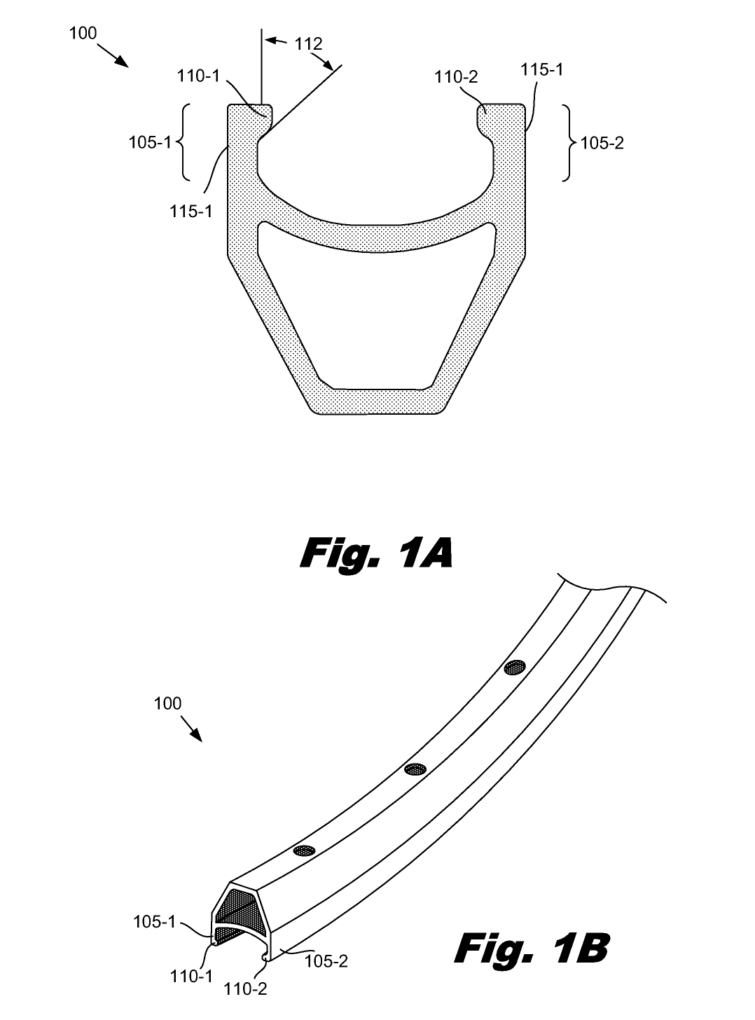

FIGS. 1A and 1B are diagrams of a rim (100) that is designed with sidewalls (105) which use bead hooks (110) to retain a tire. The bead hooks (110) are inward protrusions on the upper end of the sidewalls (105). The bead hooks (110) are designed to retain the bead of the tire in place on the rim. In some examples, the sidewalls (105) also provide braking surfaces (115) where brake pads contact the rim (100) to slow the wheel rotation.

FIG. 1C shows a cross sectional diagram of a rim (100) that includes bead hooks (110) to retain the beads (145) of the tire (125) in place. Beads (145) are typically formed using a loop of metal wire which is formed into the lip of the tire. The ends of the metal wire are generally not connected so that the loop is interrupted and not a complete circle. Rather, the ends of the bead are bonded to the rubber which makes up the tire (125). These “floating” ends of the metal wire allow the bead to expand slightly.

In this example, the tire (125) is inflated by introducing air into the inner tube (130) through the stem (140). This creates higher pressure within the inner tube (130). This pressure is restrained by the tire (125), the rim (100), and the beads (145).

The beads (145) are structural components which are designed to prevent the outward radial expansion of the tire (125) when inflated. However, when subject to the pressure forces caused by the inflation of the tire, dynamic forces generated during cycling, and heating caused by braking, the beads (145) can expand. The bead hooks (110) are designed to accommodate this expansion and still retain the tire (125) on the rim (100).

However, the presence of bead hooks increases the cantilever forces that the rim sidewalls must withstand. The bead hooks (110) concentrate significant force at the tip of the side walls. This cantilever force is illustrated as two arrows in FIG. 1C.

As a result of this cantilever force several issues are introduced. For example, to resist this cantilever force, the sidewalls are made significantly thicker than would otherwise be necessary. Moreover, the cantilever force will naturally increase the stress and wear on a rim and thus result in shorter rim life. Additionally, the cantilever force can limit the inflation pressure of tires that are mounted to the rim.

The presence of bead hooks may also decrease the reliability of the wheel due to “pinch flats.” Pinch flats occur when the bicycle wheel strikes an obstacle and the tire is pinched between the obstacle and the wheel rim. The characteristic pattern of a pinch flat is the presence of two small holes on either side of the tire where the tire was pinched between the obstacle and the bead hooks.

The bead hooks also increase the mass or the rim. The bead hooks increase the mass of the rim in two ways: the material which makes up the bead hooks increases the mass of the rim, and the increased stress produced by the bead hooks results in thicker sidewalls, as noted above.

The presence of bead hooks can also limit the versatility of a rim. Tires have a variety of designs, including tires that use inner tubes and tubeless tires. A rim with bead hooks is designed for and limited to only one or the other of these types of tire.

The presence of bead hooks also increases the cost of producing the rim. The bead hooks create a negative draft angle (112, FIG. 1A) on the interior of the rim. This negative draft angle can require more complex forming tools than geometries without negative draft angles. For example, when wheel rims are formed from composite fibers, the presence of the bead hooks can require a more complex multipart curing mold which is disassembled to allow it to be withdrawn from the rim. When the wheel rims are formed from metal, the formation of the bead hooks can require several additional forming steps. When the wheel rims are injection molded, the mold can be significantly more complex to accommodate the bead hook geometry.

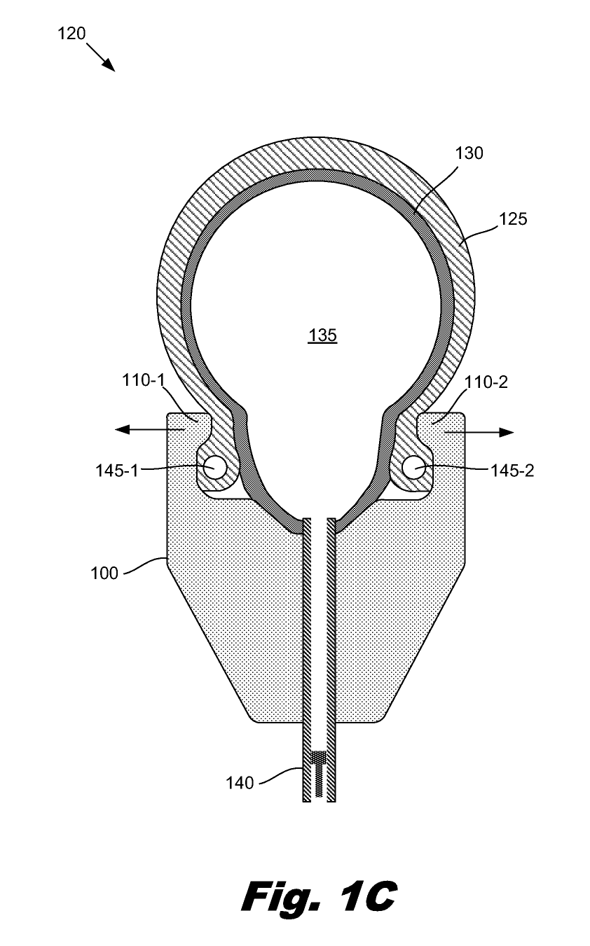

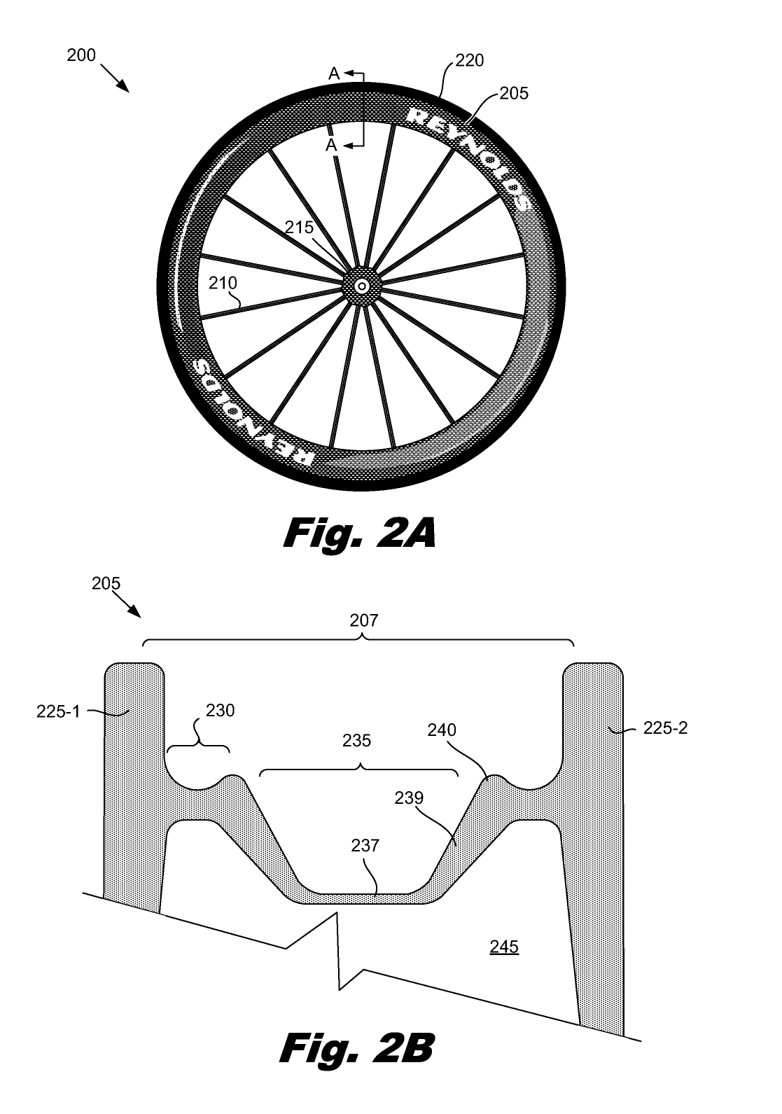

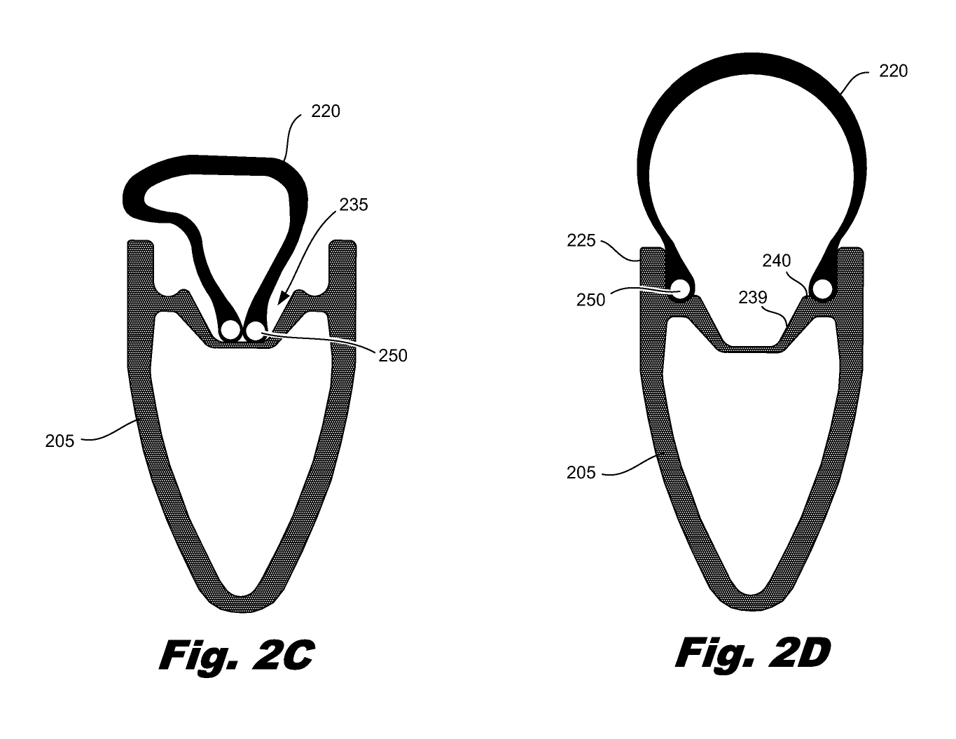

FIG. 2A shows a side view of an illustrative bicycle wheel (200) which includes a bead seat clincher rim (205) according to novel principles disclosed herein. The bicycle wheel (200) also includes a tire (220) mounted to the rim (205), a hub (215), and spokes (210) which attach the rim (205) to the hub (215).

FIG. 2B is a partial cross section of the bead seat clincher rim (205) taken along line A-A. The bead seat clincher rim (205) includes a tire support surface (207) that forms an open cavity that retains the tire (220). The tire support surface (207) is bounded on the left and right by two sidewalls (225) that do not have inwardly protruding bead hooks. In contrast, the sidewalls (225) have substantially parallel edges along their length.

The two sidewalls (225) are joined by a bridge (237). The bridge includes a central indentation (235) with ascending slopes (239) that lead to elevated retention features (240). According to one illustrative example, the radial height of retention features (240) is between approximately 0.010 inches and 0.050 inches. Between the retention features (240) and the sidewalls (235), cups (230) are formed. The cups (230) are localized depressions in the tire support surface. When the tire is inflated, the beads are retained within the cups by tension within the beads.

As a result of eliminating the bead hooks used in most all previous bicycle wheel rims, the rim (205) illustrated here is free of the issues caused by bead hooks. For example, no cantilever forces affect the design, performance or life expectancy of the rim (205). Moreover, the rim is easier to manufacture without any negative sloping surfaces as are needed for forming bead hooks.

FIGS. 2C and 2D are cross sectional diagrams of a tire being installed and inflated on the illustrative bead seat clincher rim (205). Generally, this tire would differ from a traditional bicycle tire in that the bead may be a continuous, uninterrupted circular loop without floating ends.

Additionally, bicycle rims and tires are designed for inflation pressures that far exceed that used for other types of vehicles. For example, bicycle tires may be inflated to between 100 and 200 pounds-per-square-inch (PSI) of pressure or more. This introduces special design considerations that make bicycle tire design unique as compared to other vehicles.

FIG. 2C is shows an uninflated tire (220) mounted on the rim (205) with the beads resting in the central indentation (235, FIG. 2B) of the rim (205). The central indentation (235) is specifically designed to have a reduced diameter that allows the tire (220) to be mounted by placing the both tire beads (235) at one radial location into the central indentation (250) and then working remaining portions the tire beads (250) over the sidewalls. Once the entire circumference of the tire beads (250) rests in the central indentation (235), the tire (220) can be inflated.

FIG. 2D shows the tire (220) inflated with the tire beads (250) seated in the cups (255) and against the sidewalls (225). As the tire (220) is inflated, the tire expands and pushes the beads (250) both axially and radially outward. This pulls the beads (250) of the tire (220) up the ascending slopes (239) and over the elevated retention features (240).

Once the beads (250) reach the top of the elevated retention features (240), the beads (250) snap down into the cup-shaped portion (255) of the tire supporting surface (235). The beads are also pressed against the sidewalls (225) of the rim (205).

The beads (250) prevent the inflated tire from further radial expansion. The sidewalls (225) prevent the beads (250) from axially expanding. As noted above, this effect is facilitated where the beads are formed from one continuous length of cable which is wound around the tire multiple times. Thus, the interaction between beads (250) and the rim (205) hold the inflated tire (220) in place.

According to one example, the beads (250) are formed from multiple coils of a single length of aramid fiber. The single length of aramid fiber passes around the lip of the tire multiple times to form the bead (250). Beads which are manufactured in this way stretch less when the tire is inflated than beads which are constructed from a single loop with floating ends. Because the beads (250) have substantially less expansion there is no need for the rim (205) to have bead hooks on the sidewalls.

Rims with straight sidewalls (225) may have the following characteristics and benefits. The absence of bead hooks on the sidewalls more uniformly distributes the pressure loading from the tire (220). Consequently, the tires (220) can be inflated to higher pressures and the rims (205) have longer lifetimes. Additionally, the straight sidewalls (225) increase the reliability of the wheel because they reduce the occurrence of “pinch flats.” The straight sidewalls (225) decrease the mass of the rim (205) because of the absence of bead hooks and because better distribution of forces across the sidewall surface allows the sidewalls to be made thinner. The straight sidewalls (225) can also accommodate both tires that using inner tubes and tubeless tires.

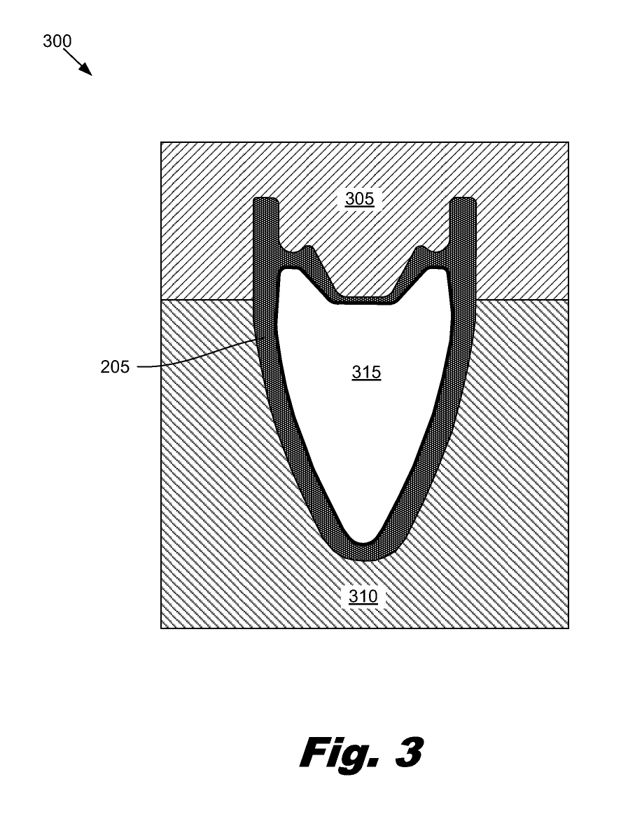

Another advantage of using straight sidewalls is a reduction in manufacturing complexity and cost. FIG. 3 shows a composite mold (300) includes a lower portion (310) and a single piece upper portion (305). To form a composite rim, the composite plies are laid into the mold. A bladder (315) is inflated to form the interior cavity (245, FIG. 2B) and to press the composite plies against the mold. To cure the composite material, the bladder is inflated with a gas or liquid to a desired pressure and the mold (300) is heated in a curing oven according to a specified temperature profile.

After the curing is complete, the pressure in the bladder (315) is released and the upper and lower portions (305, 310) are removed from the rim (205). Significant costs in producing a composite rim include the purchase of the mold and the time/labor involved in molding and curing process.

Because there are no bead hooks on the sidewalls, the upper portion (305) of the mold can be a single piece. This is a significant savings over a mold which must have multiple parts to form overhanging bead hooks.

Further, the assembly of the mold prior to curing and the disassembly of the mold after curing is simpler and more rapid with a single upper piece mold. The single upper piece of the mold can be extracted in a single action. In contrast, the more complex mold used to mold sidewalls with bead hooks requires the precise assembly and disassembly of multiple parts.

The bicycle rim described herein could be formed from a variety of materials. Such materials include, but are not limited to, carbon, boron, glass, aramid, other fibers or combinations of fibers.

According to one illustrative example, the rim is constructed from multiple plies of unidirectional fibers. Within each of these plies, the unidirectional fibers are generally parallel to each other. Each ply of unidirectional material is laid within a mold, one on top of another, so that the unidirectional material of each ply is oriented with respect to the underlying or overlying plies at predetermined crossing angles. The bicycle rim could include a variety of other materials such as woven composite fabric.

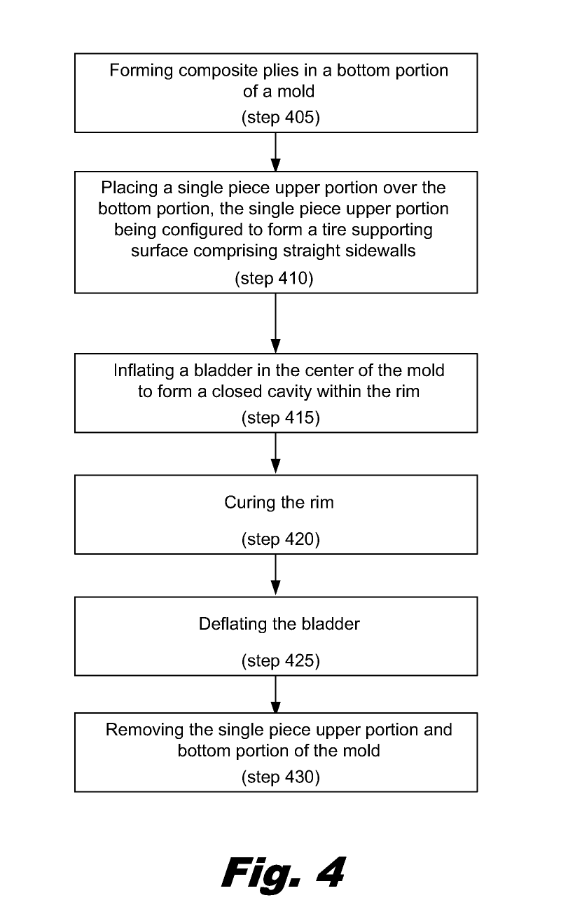

FIG. 4 is a flow chart which shows one illustrative method for forming a bead seat clincher rim according to principles disclosed herein. The method includes forming composite plies in a bottom portion of a mold (step 405) and placing a single piece upper portion over the bottom portion, the single piece upper portion being configured to form a tire supporting surface comprising straight sidewalls (step 410).

A bladder is inflated in the center of the mold to form a closed cavity within the rim and to press the composite plies against the mold surfaces (step 415). The rim is then cured (step 420) while the bladder is still inflated. Following the curing process, the bladder is deflated and removed (step 425) and the single piece upper portion and bottom portion of the mold are removed (step 430).

The steps described above are only one illustrative example of a method for forming a bead seat clincher rim. A number of steps could be added, combined or removed from the method described above. For example following the removal of the rim from the mold a number of post cure tasks such as trimming, drilling, cleaning or joining could be performed.

In conclusion, the specification and figures describe a bead seat clincher rim which has tire supporting surface with straight sidewalls. The straight sidewalls provide a number of benefits including reducing the weight of the rim, increasing the lifetime of the rim, increasing the maximum tire pressure the rim can support, and decreasing the cost manufacturing the rim.

The preceding description has been presented only to illustrate and describe examples and examples of the principles described. This description is not intended to be exhaustive or to limit these principles to any precise form disclosed. Many modifications and variations are possible in light of the above teaching.

What is claimed is:

1. A bead seat clincher bicycle rim comprising a tire supporting surface bounded by a first straight sidewall and a second straight sidewall wherein said bicycle rim does not comprise bead hooks.

2. The rim of claim 1, in which the rim comprises unidirectional plies of composite material.

3. The rim of claim 1, in which the wheel rim comprises carbon fiber.

4. The rim of claim 1, in which the tire supporting surface comprises a central indentation.

5. The rim of claim 1, in which the tire supporting surface comprises elevated retention features which extend radially outward such that tire beads must expand to go over the elevated retention features.

6. The rim of claim 5, in which the elevated retention features have a height between 0.005 inches and 0.050 inches.

7. The rim of claim 5, in which the rim comprises a central indentation which includes a flat bottom with sides that form ascending slopes from the flat bottom to the elevated retention features.

8. The rim of claim 7, in which the elevated retention features are interposed between the ascending slopes and cups such that the tire beads are expanded as they travel up the ascending slopes and then snap into the cups.

9. The rim of claim 1, in which a tire mounted to the rim comprises a bead formed from single length of cable which passes around the tire lip multiple times.

10. The rim of claim 1, in which the bead is formed from aramid fiber.

11. The rim of claim 1, in which the tire supporting surface has two distinct and stable positions for the beads; a first position in a central cavity and a second position in cups adjacent to the straight sidewalls.

12. A bead seat clincher wheel comprising:
a tire comprising a bead formed from a single length of cable which passes around the tire lip multiple times; and
a rim comprising a cup bounded by an elevated feature and a straight sidewall, the cup comprising a localized depression;
wherein the bead is disposed within the cup when the tire is inflated.

13. The wheel of claim 12, in which the tire is a tubeless tire, in which tension in the single length of cable in the bead forms an air tight seal between the bead and the rim when the tire is inflated.

14. The wheel of claim 12, in which the rim does not comprise bead hooks.

15. The wheel of claim 12, in which rim comprises a plurality unidirectional composite plies.

16. The wheel of claim 12, in which a tire supporting surface on the rim does not comprise negative draft angles.

17. A bicycle wheel comprising:
a carbon composite bead seat clincher rim with a tire supporting surface, the tire supporting surface comprising:
a central indentation with sides having ascending slopes on either side;
elevated retention features which extend radially outward such that tire beads must expand to go over the elevated retention features;
straight sidewalls; and
cups adjacent to the straight sidewalls, in which the elevated retention features are interposed between the ascending slopes and the cups; and
a tire mounted to the rim such that when the tire is inflated, beads of the tire are supported by the cups and the straight sidewalls of the tire supporting surface.

18. The wheel of claim 12, in which the tire is a tubeless tire.

19. The wheel of claim 13, further comprising an inner tube disposed within the tire.

20. A method for forming a bead seat clincher rim, the method comprising:
forming composite plies in a bottom portion of a mold;
placing a single piece upper portion over the bottom portion, the single piece upper portion form configured to form a tire supporting surface comprising straight sidewalls;
inflating a bladder in the center of the mold to form a closed cavity within the rim;
curing the rim;
deflating the bladder; and
removing the single piece upper portion and the bottom portion of the mold.
